(19) United States
(12) Patent Application Publication
(10) Pub. No.: US 2017/0225312 A1
(43) Pub. Date: Aug. 10, 2017

(54) TENT PEG HAMMER ASSEMBLY

(71) Applicant: Hsien-Hai LIAO, Taichung City (TW)

(72) Inventor: Hsien-Hai LIAO, Taichung City (TW)

(21) Appl. No.: 15/017,439

(22) Filed: Feb. 5, 2016

(51) Int. Cl. B25D 1/16; E04H 15/32

(52) U.S. Cl. CPC B25D 1/16; E04H 15/32

(57) ABSTRACT

A hammer assembly has a guiding unit, an impacting block, and a fastening assembly. The guiding unit is elongated and has a body, a limiting portion, and a limiting unit. The body has a first end and a second end opposite the first end of the body. The limiting portion is disposed at the first end of the body. The limiting unit is disposed closely to the second end of the body. The impacting block is movably mounted around the body of the guiding unit and blocked by the limiting portion and the limiting unit of the guiding unit. The fastening assembly has a fastening seat connected with the second end of the body. The fastening seat has a positioning structure for fastening a tent peg. The positioning structure may be a receiving recess or a threaded hole.

### BACKGROUND OF THE INVENTION

### 1. Field of the Invention

The present invention relates to a tool for driving and extracting stakes or pegs, and more particularly to a hammer assembly that is applied for driving tent pegs.

### 2. Description of Related Art

For pitching a tent, multiple tent pegs have to be driven into the ground to fix the camp ropes of the tent. The usual way to drive the tent pegs into the ground is striking the tent peg with a peg hammer. The conventional peg hammer has a striking head and a claw opposite the striking head. However, as the striking head of the peg hammer is hard to aim at the tent peg, the hand of the user that holds the tent peg may be easily injured by the peg hammer when the other hand moves the peg hammer to strike the tent peg. The force exerted on the tent peg does not transfer along the tent peg, is not easy to concentrate on the tent peg, and causes the difficulties of driving or pulling the tent peg.

To overcome the shortcomings of the conventional peg hammer, the present invention provides a tent peg hammer assembly to mitigate or obviate the aforementioned problems.

### SUMMARY OF THE INVENTION

The main objective of the present invention is to provide a convenient and safe tool for driving and extracting a stake or a peg of the tent.

The hammer assembly comprises a guiding unit, an impacting block, and a fastening assembly. The guiding unit is elongated and has a body, a limiting portion, and a limiting unit. The body has a first end and a second end opposite the first end of the body. The limiting portion is disposed at the first end of the body. The limiting unit is disposed closely to the second end of the body. The impacting block is movably mounted around the body of the guiding unit and blocked by the limiting portion and the limiting unit of the guiding unit. The fastening assembly has a fastening seat connected with the second end of the body. The fastening seat has a positioning structure for fastening a tent peg. The positioning structure may be a receiving recess or a threaded hole.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a hammer assembly in accordance with the present invention;

FIG. 2 is an exploded perspective view of the hammer assembly in FIG. 1;

FIG. 3 is a side view in partial section of the hammer assembly in FIG. 1;

FIG. 4 is an operational side view of the hammer assembly in FIG. 1 for driving a tent peg into the ground;

FIG. 5 is another operational side view of the hammer assembly in FIG. 1 for driving the tent peg into the ground; and

FIG. 6 is an operational side view of the hammer assembly in FIG. 1 for pulling the tent peg out of the ground.

### DETAILED DESCRIPTION OF PREFERRED EMBODIMENT

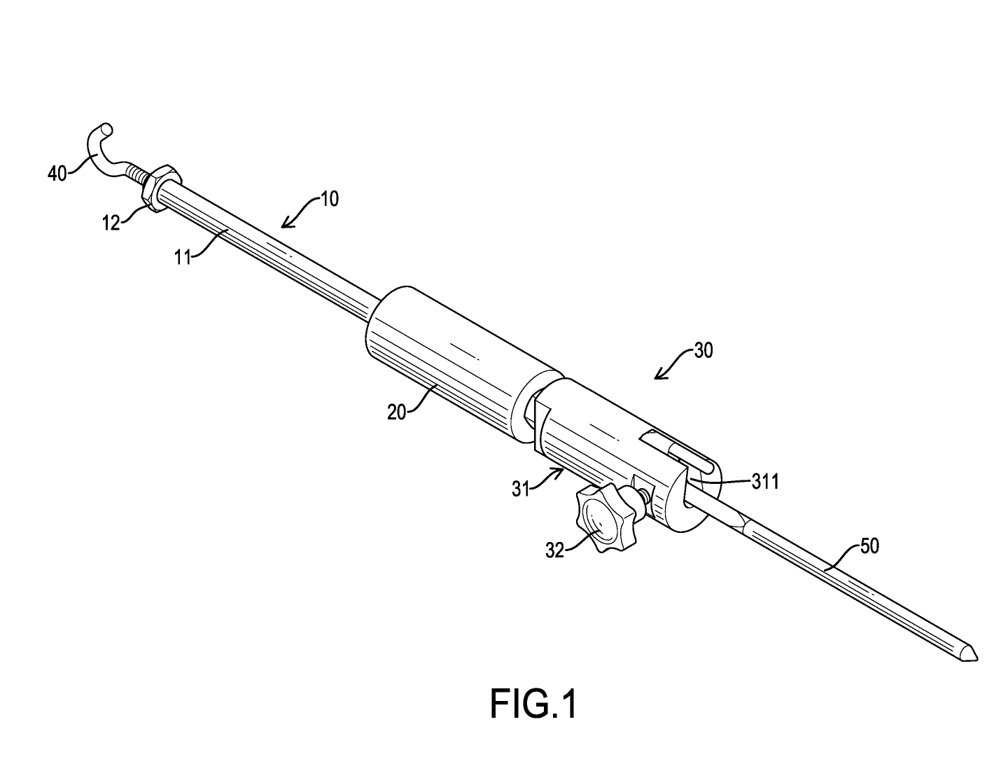

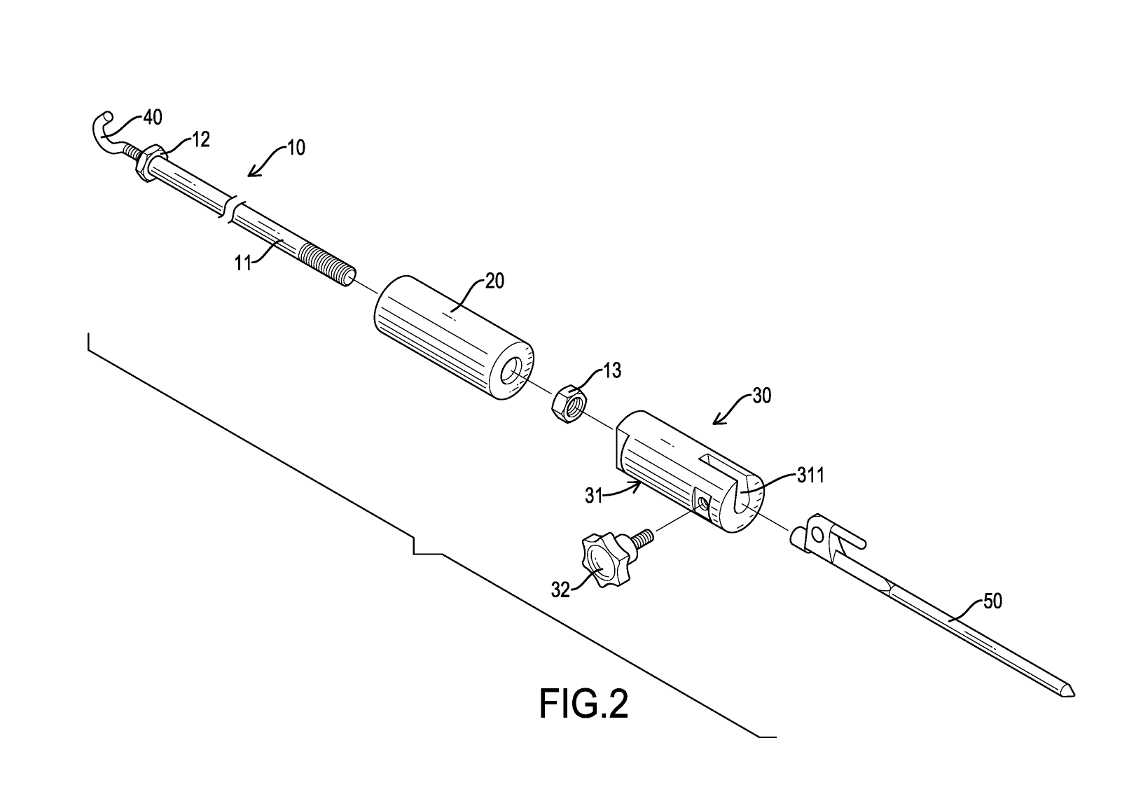

With reference to FIG. 1 and FIG. 2, a hammer assembly has a guiding unit 10, an impacting block 20, a fastening assembly 30, and a puller 40.

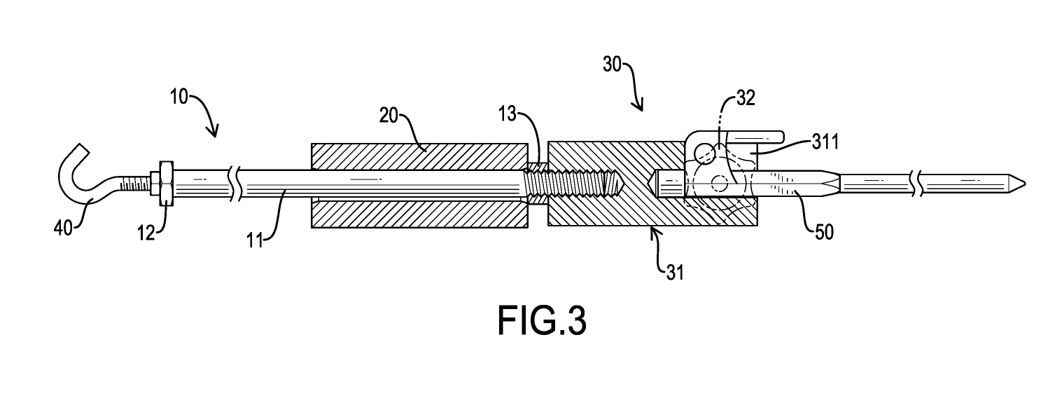

With reference to FIGS. 1, 2, and 3, the guiding unit 10 is elongated and has a body 11, a limiting portion 12, and a limiting unit 13. The body 11 is rod-shaped and has a first end, a second end, a peripheral surface, and an outer thread. The first end and the second end of the body 11 are opposite each other. The outer thread is disposed at the second end of the body 11 and is formed around the peripheral surface of the body 11. The limiting portion 12 is formed at the first end of the body 11. The limiting unit 13 is adjacent to the second end of the body 11. The limiting unit 13 is a nut and is screwed with the outer thread of the body 11.

With reference to FIGS. 1, 2, and 3, the impacting block 20 is movably mounted around the body 11 of the guiding unit 10 and is between the limiting portion 12 and the limiting unit 13 of the guiding unit 10. The impacting block 20 is limited by the limiting portion 12 and the limiting unit 13 of the guiding unit 10.

With reference to FIGS. 1, 2, and 3, the fastening assembly 30 has a fastening seat 31 and a fixing unit 32. The fastening seat 31 is connected with the second end of the body 11 and has two opposite ends, a fixing hole, a peripheral surface, and a positioning structure for locating a tent peg 50. Each one of the two ends of the fastening seat 31 respectively has an end face. The fixing hole is axially defined in the end face of one of the ends of the fastening seat 31. The fixing hole has an inner surface and an inner thread formed on the inner surface of the fixing hole. The fixing hole of the fastening seat 31 is screwed with the outer thread of the body 11 and the end face in which the fixing hole is defined abuts against the limiting unit 13. The limiting unit 13 and the fastening seat 31 may be rotated to adjust a distance between the limiting portion 12 and the limiting unit 13 of the guiding unit 10 to set a stroke of the impacting block 20. The positioning structure is disposed at the other end of the fastening seat 31 and away from the limiting unit 13. The positioning structure may be a threaded hole defined in the end face of one of the ends of the fastening seat 31 that is away from the limiting unit 13 for screwing with the tent peg 50 with an outer thread. Alternatively, the positioning structure may be a receiving recess 311 radially formed in the peripheral surface of the fastening seat 31 for containing the tent peg 50. The receiving recess 311 has an opening and a bottom. The opening of the receiving recess 311 is disposed on the peripheral surface of the fastening seat 31. The bottom is opposite the opening of the receiving recess 311, is disposed inside the fastening seat 31, and is wider than the opening of the receiving recess 311. The fixing unit 32 is connected with the fastening seat 31. The fixing unit 32 is a knob with a threaded stud. The fixing unit 32 is screwed with the peripheral surface of the fastening seat 31. The threaded stud of the fixing unit 32 extends into the receiving recess 311 and a position of the fixing unit 32 is radially adjustable.

With reference to FIGS. 1, 2, and 3, the puller 40 is hook-shaped and is connected with the limiting portion 12 of the guiding unit 10.

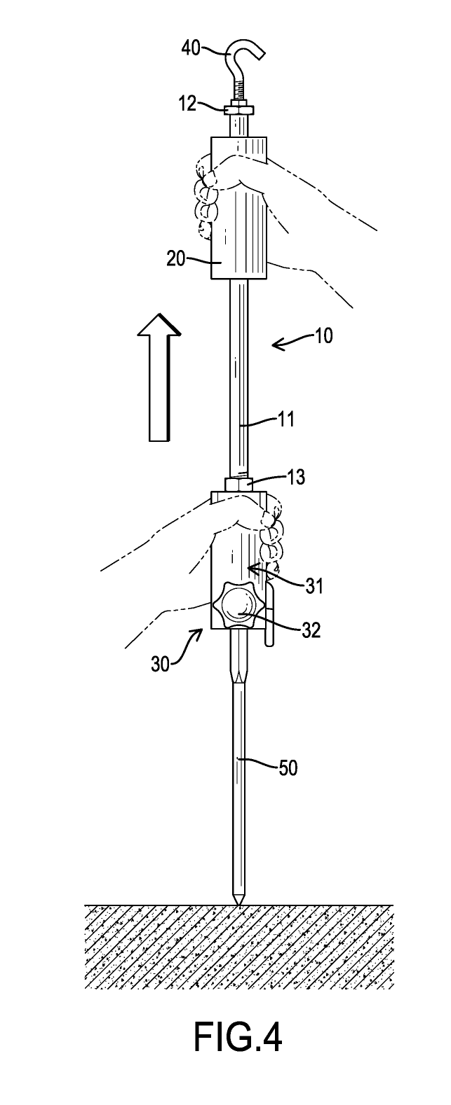

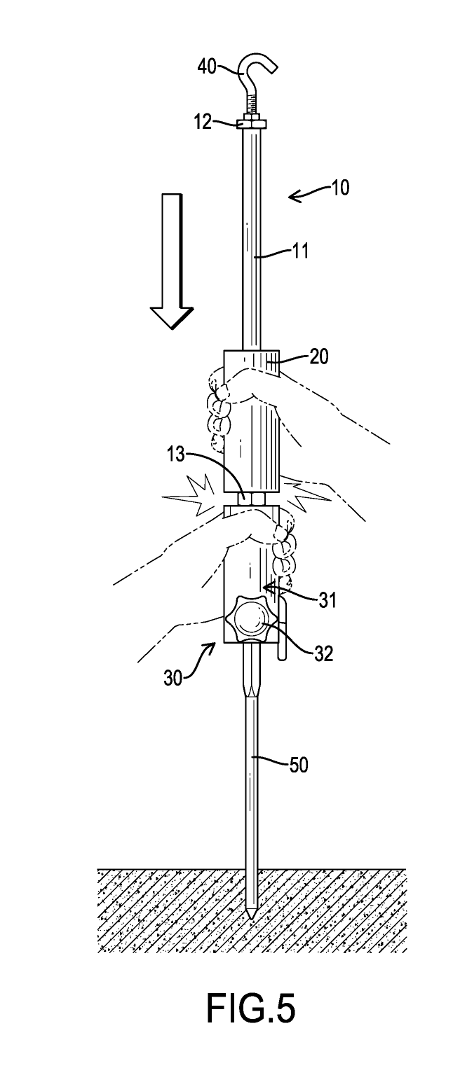

With reference to FIG. 4 and FIG. 5, the tent peg 50 has a hook end and a sharp end opposite the hook end of the tent peg 50. The hook end of the tent peg 50 is inserted into the receiving recess 311. Rotating the fixing unit 32 makes the fixing unit 32 move radially and abut against the tent peg 50. The fixing unit 32 is used for fixing the tent peg 50 and can prevent the tent peg 50 from detaching from the receiving recess 311 of the fastening seat 31. The sharp end of the tent peg 50 is pointed to the ground and the impacting block 20 is slid up and down. The impacting block 20 strikes the limiting unit 13 and applies the force of impact to the fastening seat 31. The force of impact drives the tent peg 50 into the ground. The hammer assembly in accordance with the present invention can be easily operated and avoid missing the hook end of the tent peg 50.

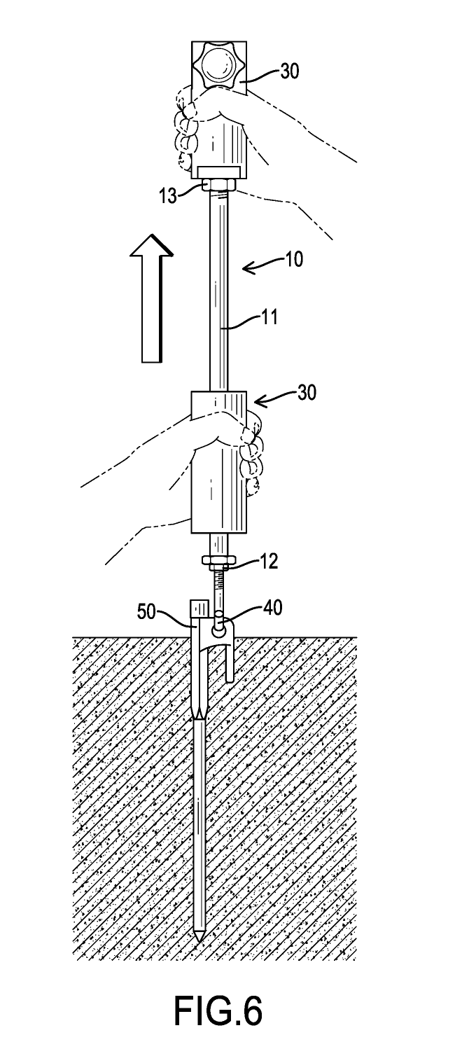

With reference to FIG. 6, the hook end of the tent peg 50 is hooked by the puller 40 and then the impacting block 20 slides to strike the limiting portion 12 of the guiding unit 10. The force of impact makes the puller 40 drag the tent peg 50 upward. Therefore, the hammer assembly in accordance with the present invention can pull the tent peg 50 out of the ground safely and easily.

The impacting block 20 slides up and down to strike the limiting portion 12 and the limiting unit 13 of the guiding unit 10. The impact force provided by the impacting block 20 is parallel to and transfers along the tent peg 50, saves the physical effort of operation, and makes the tent peg 50 easily driven into or pulled out of the ground. The hammer assembly in accordance with the present invention avoids missing the hook end of the tent peg 50, hardly injures the hands of the user during operation, and has merits of effort saving, safe and convenient.

The hammer assembly in accordance with the present invention is suitable for various kinds of pegs or stakes by adopting appropriate tools, and can be applied to agriculture for erecting trellises or pergolas as well. A suitable punching pin mounted on the fastening seat 31 of the hammer assembly can punch a hole on tubes, bars or rods.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hammer assembly comprising:
a guiding unit being elongated and having
a body having
a first end; and
a second end opposite the first end of the body;
a limiting portion disposed at the first end of the body; and
a limiting unit disposed adjacent to the second end of the body;
an impacting block movably mounted around the body of the guiding unit, being between the limiting portion and the limiting unit, and selectively limited by the limiting portion and the limiting unit; and
a fastening assembly having
a fastening seat connected with the second end of the body and having two opposite ends; and
a positioning structure formed at one of the two ends of the fastening seat that is away from the limiting unit.

2. The hammer assembly as claimed in claim 1, wherein
the fastening seat has a peripheral surface; and
the positioning structure is a receiving recess radially formed in the peripheral surface of the fastening seat.

3. The hammer assembly as claimed in claim 2, wherein
the fastening assembly further has a fixing unit connected with the fastening seat, and the fixing unit extends into the receiving recess and a position of the fixing unit in the fastening seat is radially adjustable.

4. The hammer assembly as claimed in claim 3, wherein
the receiving recess has
an opening disposed on the peripheral surface; and
a bottom opposite the opening of the receiving recess, disposed inside the fastening seat, and being wider than the opening of the receiving recess.

5. The hammer assembly as claimed in claim 3, wherein
the fixing unit is screwed with the peripheral surface of the fastening seat.

6. The hammer assembly as claimed in claim 3, wherein
the second end of the body is screwed with the end of the fastening seat that is away from the receiving recess.

7. The hammer assembly as claimed in claim 1, wherein
each one of the two ends of the fastening seat respectively has an end face;
the positioning structure is a threaded hole defined in the end face of one of the two ends of the fastening seat that is away from the limiting unit.

8. The hammer assembly as claimed in claim 7 further comprising a puller, wherein the puller is hook-shaped and is connected with the limiting portion of the guiding unit.

10. The hammer assembly as claimed in claim 1 further comprising a puller wherein the puller is hook-shaped and is connected with the limiting portion of the guiding unit.

11. The hammer assembly as claimed in claim 2 further comprising a puller wherein the puller is hook-shaped and is connected with the limiting portion of the guiding unit.

12. The hammer assembly as claimed in claim 3 further comprising a puller wherein the puller is hook-shaped and is connected with the limiting portion of the guiding unit.

13. The hammer assembly as claimed in claim 4 further comprising a puller wherein the puller is hook-shaped and is connected with the limiting portion of the guiding unit.

14. The hammer assembly as claimed in claim 5 further comprising a puller wherein the puller is hook-shaped and is connected with the limiting portion of the guiding unit.

15. The hammer assembly as claimed in claim 6 further comprising a puller wherein the puller is hook-shaped and is connected with the limiting portion of the guiding unit.
